(19) United States
(12) Patent Application Publication
(10) Pub. No.: US 2009/0286215 A1
(43) Pub. Date: Nov. 19, 2009

(54) Method for reducing the use of antipsychotic medications

(76) Inventor: Louis M. Mudannavake, Brooklyn, NY (US)

Correspondence Address: Dara L. Onofrio, Esq.;c/o ONOFRIO LAW, Suite 225, 15 N. Mill Street, Nyack, NY, 10960, US

(21) Appl. No.: 12/387,682

(22) Filed: May 6, 2009

Related U.S. Application Data
(60) Provisional application No. 61/126,772, filed on May 7, 2008.

(51) Int. Cl. G09B 19/00

(52) U.S. Cl. 434/236

(57) ABSTRACT

A method to reduce or discontinue the use of antipsychotic medications in a patient, comprising a multidisciplinary team with members including a physician, psychiatrist, pharmacist, nurse, antipsychotic social worker and a therapeutic recreationist; wherein said members are in communication with each other to monitor and taper the use of antipsychotic medications and to substitute sustainable behavioral interventions on the patient.

This application claims the benefit of U.S. provisional application No. 61/126,772 filed May 7, 2008, which is incorporated herein in its entirety by reference.

### FIELD OF THE INVENTION

The present invention relates to a method to reduce or discontinue the use of antipsychotic medications in a patient. In particular, an antipsychotic and behavioral system comprising a multidisciplinary team is provided for the reduction or elimination of atypical antipsychotic medications in the institutionalized elderly.

### BACKGROUND OF THE INVENTION

In the United States of America, and throughout the world, there is a problem with excessive and inappropriate use of antipsychotic medications in the institutionalized elderly. Three atypical antipsychotic medications: Olanzapine (Zyprexa), Quetiapine (Seroquel) and Riperidone (Risperdal), alone constitute a $13 billion industry. These medications show no convincing benefit when used on psychotic demented elderly and may actually harm these people.

In two Wall Street Journal articles, one dated Dec. 4, 2007 entitled “Prescription Abuse Seen in U.S. Nursing Homes: Powerful Antipsychotics Used to Subdue Elderly Huge Medical Expense”; and the other dated Dec. 20, 2007 entitled “Nursing Homes Struggle to Kick Drug Habit: New Therapies Sought For Dementia Sufferers, Music and Massages” a vivid picture of the current abusive use of antipsychotic medications in the elderly is described. These articles are incorporated in their entirety herein.

There are a rising number of institutionalized elderly with dementia and psychosis. Nursing homes or facilities that care for the elderly must maintain a quality of care for their patients and not just medicate them to be artificially calm.

More than a quarter of nursing home residents across the nation receive antipsychotics. More than 50% of nursing home residents may be receiving the antipsychotic medications inappropriately.

In a trial study elderly patients with dementia-related psychosis treated with atypical antipsychotic drugs were at an increased risk of death compared to the group treated with a placebo. Analysis of placebo-controlled trials (modal duration of 10 weeks) in these patients revealed a risk of death in the drug-treated patients between 1.6-1.7 times that seen in placebo-treated patients. Over the course of a typical 10-week controlled trial, the rate of death in drug-treated patients was about 4.5% compared to about 2.6% in the placebo group. Although the causes of death were varied, most of the deaths appeared to be either cardiovascular (e.g. heart failure, sudden death) or infectious (e.g. pneumonia) in nature.

Based on these studies, in 2005 the Food and Drug Administration actually issued a “black box” warning on use of atypical antipsychotics for dementia patients. The “black box” warning was that elderly dementia patients using these medications face a higher risk of death.

Further, in December 2006, the Federal Government included antipsychotics in unnecessary medications regulations (FTAG 329 Revised). The regulations state that antipsychotics may be used based on a comprehensive assessment of a resident and that the facility must ensure that:
Residents who have not used antipsychotic drugs are not given these drugs unless antipsychotic drug therapy is necessary to treat a specific condition as diagnosed and documented in the clinical record; and
Residents who use antipsychotic drugs receive gradual dose reductions, and behavioral interventions, unless clinically contraindicated, in an effort to discontinue these drugs.

Most nursing home facilities for the elderly do not follow these regulations and the elderly are unnecessarily treated with antipsychotic drugs which drastically reduce their quality of life and even risks of death. The antipsychotic medications are given to the institutionalized patient to artificially calm them. Serious side effects of administering these drugs can result and even cause death.

The method of the invention uses systematic sustainable behavioral intervention by a multidisciplinary team whose members communicate with each other to 1) significantly reduce antipsychotic use in nursing homes without the need for additional staff and 2) to improve the quality of life of elderly demented, psychotic institutionalized elderly.

The antipsychotic and behavioral system of the invention general objectives are to 1) identify the residents with dementia who are being treated with antipsychotics; 2) ensure indications, monitoring and results on target behavior are appropriate; 3) based on 2, evaluate the risks vs. benefits; and 4) institute and maintain sustainable non-pharmacological management approach.

An objective of the invention is to provide a method for a reduction or elimination of inappropriate antipsychotic medication use in demented nursing home residents and improvement in the quality of life of these individuals.

Another objective of the invention process is to identify individuals with dementia who are being treated with antipsychotic medicines and to ensure that indications, monitoring and results on target behavior are appropriate.

Yet a further object of the invention is a means for evaluating the risks vs. benefits for individuals being treated with antipsychotic medicines, in particular the elderly and institutionalized.

Still another object of the invention is to institute and maintain a sustainable non-pharmacological management approach to individuals being treated with antipsychotic medicines.

### SUMMARY OF THE INVENTION

In the present invention, these purposes, as well as others which will be apparent by providing a method to reduce or discontinue the use of antipsychotic medications in patients.

The method includes a multidisciplinary team with members including a physician, psychiatrist, consultant pharmacist, charge nurse, antipsychotic social worker, a therapeutic recreationist and a nurse's aide. The members are in communication with each other to monitor and taper the use of antipsychotic medications and to substitute sustainable behavioral interventions on the patient to improve their quality of life.

The physician reviews the patient's case with the psychiatrist and pharmacist to determine whether the indication, monitoring for physical and biochemical adverse effects and results on target of the physician are appropriate.

The psychiatrist evaluates indications for psychotic behavior which may or may not warrant the use of antipsychotic medications and watches for side effects.

The consultant pharmacist reviews indications and monitoring with the physician and the nurse;

The nurse gives detailed descriptions of the patients behavior and triggers to these behaviors to the physician. The nurse also carries out any orders, including the monitoring and tapering of these medications issued by the physician.

The social worker communicates with the families and obtains information about the patient prior to the dementing illness and psychosis and shares this information with the team.

The therapeutic recreationist defines particular activities, such as specific music, which mitigates the adverse behavior of the patient.

A nurse's aid is also considered part of the team in helping care for the general well being of the patient.

The members of the team work together to monitior and taper the use of antipsychotic medications on an individualized basis. This non pharmacological sustainable behavioral intervention is substituted to reduce the use of the antipsychotic medications.

The side effects of antipsychotic medications are physical impairments such as IAMS and even death. The method of the invention provides the psychiatrist and physician to reduce the dose of antipsychotic medication where the risk outweighs the benefit and even permits them to discontinue the dose of antipsychotic medication.

The antipsychotic medications encompassed by the invention method, includes primarily Olanzapine (Zyprexa), Quetiapine (Seroquel), Risperidone (Risperdal), and Aprpravole (Apilify). Although these drugs are widely used, other similar medicines are also included herein.

The invention also provides an antipsychotic and behavioral system comprising a multidisciplinary team with members that communicate with each other to monitor and taper use of antipsychotic medicine in patients and substituting behavioral interventions for said medicine, improving the quality of life of said patients and potentially preventing them from sudden death caused by these medicines.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is an illustration of the multidisciplinary team members of the invention method; and

FIG. 2 compares use of antipsychotic medications in nursing-home patients without a psychotic condition in New York State and at Cobble Hill, where a test of the invention method was conducted; the results indicate that Cobble Hill uses less than 40% of antipsychotic medications as compared to other facilities in New York State; Sources: New York Association for Homes and Services for the Aging, Albany, New York, Cobble Hill Minimum Data Set, Cobble Hill Health Center, Brooklyn, New York.

### DETAILED DESCRIPTION OF THE INVENTION

In accordance with the present invention a method is provided to reduce the use of antipsychotic medications. The method uses a multidisciplinary, team approach to monitoring and tapering antipsychotic medication and substituting sustainable behavioral interventions on nursing home residents. This method improves the quality of life of these residents and potentially prevents them from sudden death caused by these medications.

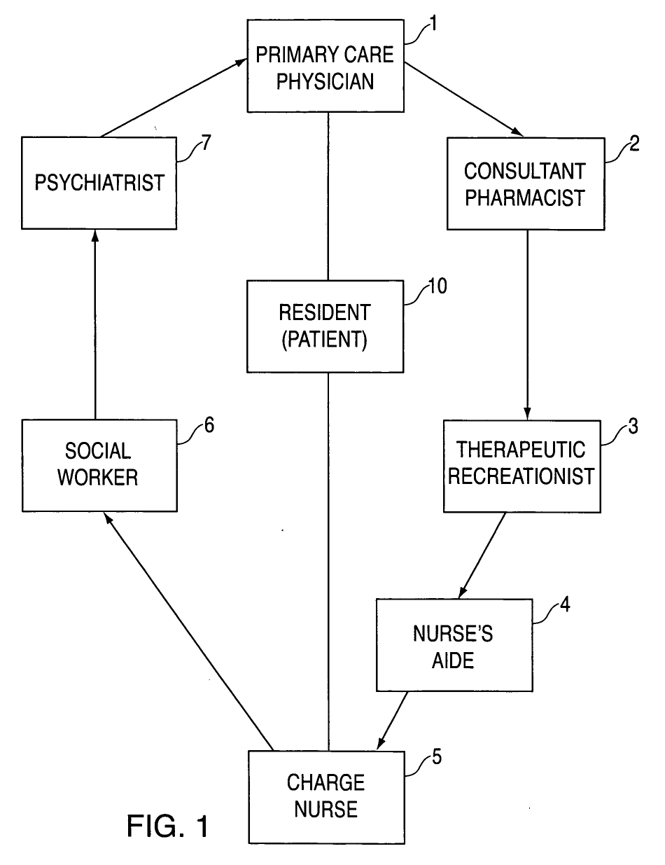

The method includes a team with members including a physician 1, psychiatrist 7, consultant pharmacist 2, charge nurse 5, antipsychotic social worker 6, a therapeutic recreationist 3 and a nurse's aide 4. FIG. 1 illustrates the relationship among the team and the resident or patient 10. The members are in communication with each other to monitor and taper use of antipsychotic medications and to substitute sustainable behavioral interventions on the patients. The sustainable behavioral interventions are described in more detail below.

The physician reviews each case with the psychiatrist and pharmacist to determine whether the indication, monitoring for physical and biochemical adverse effects and results on target physician are appropriate.

The psychiatrist evaluates indications for psychotic behavior which may or may not warrant the use of antipsychotic medications. The psychiatrist watches for side effects, including physical side effects such as IAMS and then is responsible, with the physician, for reducing doses and discontinuing these medications where the risk exceeds the benefits.

Behavioral intervention by the team further includes, review by the consultant pharmacist of the patients indications and monitoring with the physician and the nurse.

The nurse gives detailed descriptions of behaviors and triggers to these behaviors to the team members. The nurse also carries out any orders, including the monitoring and tapering of these medications issued by the physician.

The social worker communicates with the families and obtains information about the patient prior to the dementing illness and psychosis. This information is often relevant to the particular “psychotic” behavior exhibited and is shared with the team members.

The therapeutic recreationist defines particular activities, such as specific music, which mitigates the adverse behavior. The recreationist also engages the resident in activity programs.

In all instances, the team members communicate with each other, implementing behavioral intervention to reduce the amount of antipsychotic medication administered to the patient to improve the quality of life of the patient.

In a test program run at Cobble Hill Heath Center in Brooklyn, New York, the invention method resulted in a 50% reduction in the use of dangerous antipsychotic medications when the behavioral intervention system was used in on elderly people housed therein.

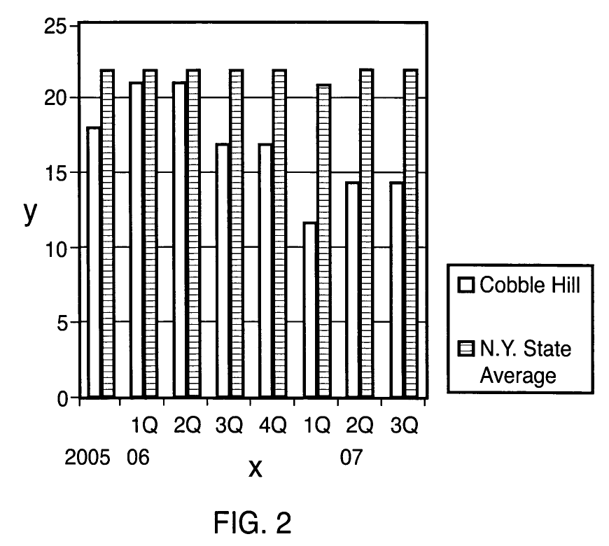

FIG. 2 compares use of antipsychotic medications in nursing-home patients without a psychotic condition in New York State and at Cobble Hill, where a test of the invention method was conducted. The results on the chart indicate that Cobble Hill uses less than 40% of antipsychotic medications as compared to other facilities in New York State. Sources: New York Association for Homes and Services for the Aging, Albany, New York, Cobble Hill Minimum Data Set, Cobble Hill Health Center, Brooklyn, New York.

The antipsychotic medications which are reduced or eliminated by the invention method include Olanzapine (Zyprexa), Quetiapine (Seroquel), Risperidone (Risperdal), and Aprpravole (Apilify). These medications and their side effects are well known in the medical profession. Although these drugs are widely used, other similar medicines that are used are also included in the invention method and system herein.

The invention also provides an antipsychotic and behavioral system comprising a multidisciplinary team with members that communicate with each other to monitor and taper antipsychotic medicine in patients and substituting sustainable behavioral interventions for said medicine, improving the quality of life of said patients and potentially preventing them from sudden death caused by these medicines.

The members include a physician, psychiatrist, pharmacist, nurse, antipsychotic social worker, a therapeutic recreationist and a nurse's aide.

In the system behavioral intervention includes reviewing the patient's case by the physician with the psychiatrist and pharmacist; wherein the psychiatrist and pharmacist determine whether the indication, monitoring for physical and biochemical adverse effects and results on target of the physician are appropriate.

Behavioral intervention also includes evaluating the patient by the psychiatrist for indications of psychotic behavior which may or may not warrant the use of antipsychotic medications.

Behavioral intervention further includes watching the patient for side effects when the medicine is administered and reducing or discontinuing said medicine when the risk exceeds the benefit to the patient.

When the side effects include any physical impairment the medicine is reduced or discontinued by the psychiatrist and physician.

The behavioral intervention also includes reviewing the patient indications and monitoring by the pharmacist with the physician and nurse; wherein the nurse provides detailed descriptions of the patient behaviors and triggers to these behaviors to the physician.

Behavioral intervention further includes said nurse carrying out orders issued by the physician, including the monitoring and tapering of said medications.

Behavioral intervention includes communicating with the family of the patient and obtaining information about the patient by the social worker prior to a dementing illness and psychosis, which information is shared with the team.

Behavioral intervention also includes defining particular activities by the therapeutic recreationist and engaging the patient in said activities to mitigate the adverse behavior of the patient.

The system provides for implementation of one or more of the behavioral interventions to reduce or discontinue the amount of antipsychotic medication administered to the patient.

The antipsychotic medication reduced by the invention method and system preferably include Olanzapine (Zyprexa), Quetiapine (Seroquel), Risperidone (Risperdal), and Aprpravole (Apilify). Antipsychotics were discovered by accident in the 1940's. The drugs bind to the brain cells' dopamine D2 receptors, blocking dopamine transmission, thus dampening the over-stimulation of the brain that dopamine is implicated in. The new generation of antipsychotic drugs, also bind to the histamine H1 receptors, inducing sedation (which can either be good or bad). The atypicals' antidepressant effects are accounted for by their actions on dopamine and serotonin pathways.

The atypicals pose many side effect risks which are well known, including IAMS, EPS, including muscle stiffness and involuntary spasms, excessive sedation, weight gain, diabetes, impotence and raised prolactin, cognitive dulling, heart rhythm irregularity and pneumonia.

In implementing the behavioral interventions of the invention, the team members consider:
Indications appropriate for behavior
Environmental triggers
Described adverse behavior
Exchange of information

They also identify the patient role and personality; ensure appropriate monitoring of drugs; and ensure lowest dose is required to control target symptoms.

The antipsychotic medication is tapered off or discontinued when:
Indications are inappropriate
Risks exceed benefits
Adverse effect interferes with quality of life (chemically schlogged)

The invention method and system is a shift away from “reaching for the medicine cabinet” and focused on behavioral intervention.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A method to reduce or discontinue the use of antipsychotic medications in a patient, comprising:
a multidisciplinary team with members including a physician, psychiatrist, pharmacist, nurse, antipsychotic social worker and a therapeutic recreationist; wherein said members are in communication with each other to monitor and taper the use of antipsychotic medications and to substitute sustainable behavioral interventions on the patient.

2. The method according to claim 1, wherein said sustainable behavioral intervention includes:
reviewing the patient's case by said physician with said psychiatrist and pharmacist;
determining by said psychiatrist and pharmacist whether the indication, monitoring for physical and biochemical adverse effects and results on target of said physician are appropriate;
evaluating the patient by said psychiatrist for indications of psychotic behavior which may or may not warrant the use of antipsychotic medications;
watching the patient for side effects when said antipsychotic medication is administered; and
reducing or discontinuing said medications when the risk exceeds the benefit to the patient.

3. The method according to claim 2, wherein said sustainable behavioral intervention further includes:
reviewing the patient indications and monitoring by said pharmacist with said physician and nurse;
providing detailed descriptions by said nurse of the patient behaviors and triggers to these behaviors to said physician and carrying out any orders, including the monitoring and tapering of these medications issued by said physician;
communicating with the family of the patient and obtaining information about the patient by said social worker prior to a dementing illness and psychosis, which information is shared with said team; and
defining particular activities by said therapeutic recreationist and engaging the patient in said activities to mitigate the adverse behavior of the patient; and
implementing the behavioral intervention to reduce the amount of antipsychotic medication administered to the patient to improve the quality of life of the patent.

4. The method according to claim 2, wherein said side effects are physical impairments such that said psychiatrist and physician reduce the dose of antipsychotic medication.

5. The method according to claim 2, wherein the side effects are physical impairments such that said psychiatrist and physician discontinue the dose of antipsychotic medication.

6. The method according to claim 1, wherein said antipsychotic medication includes Olanzapine (Zyprexa), Quetiapine (Seroquel), Risperidone (Risperdal), and Aprpravole (Apilify).

7. The method according to claim 1, wherein said team further includes a nurse's aide.

8. An antipsychotic and behavioral system comprising:
a multidisciplinary team with members that communicate with each other to monitor use of antipsychotic medicine in patients; and
behavioral intervention on the patients by said team for reducing or discontinuing use of said medicine to improve the quality of life of said patients and potentially preventing them from sudden death caused by said medicines.

9. The system according to claim 8, wherein said members include a physician, psychiatrist, pharmacist, nurse, antipsychotic social worker and a therapeutic recreationist.

10. The system according to claim 9, wherein said behavioral intervention includes reviewing the patient's case by said physician with said psychiatrist and pharmacist; wherein said psychiatrist and pharmacist determine whether the indication, monitoring for physical and biochemical adverse effects and results on target of said physician are appropriate.

11. The system according to claim 9, wherein said behavioral intervention includes evaluating the patient by said psychiatrist for indications of psychotic behavior which may or may not warrant the use of antipsychotic medications.

12. The system according to claim 8, wherein said behavioral intervention includes watching the patient for side effects when said medicine is administered and reducing or discontinuing said medicine when the risk exceeds the benefit to the patient.

13. The system according to claim 12, wherein said side effects are physical impairments such that said medicine is reduced or discontinued by the psychiatrist and physician.

14. The system according to claim 9, wherein said behavioral intervention includes reviewing the patient indications and monitoring by said pharmacist with said physician and nurse; wherein said nurse provides detailed descriptions of the patient behaviors and triggers to these behaviors to said physician.

15. The system according to claim 14, wherein said behavioral intervention further includes said nurse carrying out orders issued by said physician, including the monitoring and tapering of said medications.

16. The system according to claim 9, wherein said behavioral intervention includes communicating with the family of the patient and obtaining information about the patient by said social worker prior to a dementing illness and psychosis, which information is shared with said team.

17. The system according to claim 9, wherein said behavioral intervention includes defining particular activities by said therapeutic recreationist and engaging the patient in said activities to mitigate the adverse behavior of the patient.

18. The system according to claim 8, further comprising implementing said behavioral intervention to reduce or discontinue the amount of antipsychotic medication administered to the patient.

19. The system according to claim 8, wherein said antipsychotic medication includes Olanzapine (Zyprexa), Quetiapine (Seroquel), Risperidone (Risperdal), and Aprpravole (Apilify).

20. The system according to claim 9, wherein said members further include a nurse's aide.
